(19) United States
(12) Patent Application Publication
(10) Pub. No.: US 2014/0108610 A1
(43) Pub. Date: Apr. 17, 2014

(54) SYSTEM AND METHOD FOR MANAGING ORGANIZATIONAL PARTICIPATION IN OBJECTIVE PURSUITS

(71) Applicant: Enterprise Nube, Inc., Palo alto, CA (US)

(72) Inventor: Subhash DHAR, Palo Alto, CA (US)

(73) Assignee: Enterprise Nube, Inc., Palo Alto, CA (US)

(21) Appl. No.: 14/132,276

(22) Filed: Dec. 18, 2013

Related U.S. Application Data
(63) Continuation-in-part of application No. 13/609,899, filed on Sep. 11, 2012.
(60) Provisional application No. 61/672,470, filed on Jul. 17, 2012.
(60) Provisional application No. 61/696,182, filed on Sep. 2, 2012.

(30) Foreign Application Priority Data
Aug. 7, 2013 (IN) 3546/CHE/2013
Aug. 7, 2013 (IN) 3548/CHE/2013

(51) Int. Cl. H04L 29/08

(52) U.S. Cl. CPC H04L 67/30
USPC 709/217

(57) ABSTRACT

A system for managing organizational participation in an objective pursuit is provided. The system includes a first local computer operated by an individual and a platform for initiating an objective pursuit. The platform is capable of allowing the individual to initiate the objective pursuit of the individual's choice. The system includes a central server in communication with the first local computer. The central server is capable of creating a database for the objective pursuit. The central server includes a governance loop capable of taking permission from the individual to propagate the objective pursuit. The system provides a mechanism operated by the individual that enables the individual to take a photograph of the objective pursuits using the mechanism. The photographs may include details of the identity of the individual. The individual is capable of uploading the photograph in the platform. The system may also include an objective pursuit ledger to record the objective pursuits.

### RELATED APPLICATIONS

This application is a continuation-in-part application of and claims priority to U.S. patent application Ser. No. 13/609,899 filed on Sep. 2, 2012 titled “SYSTEM AND METHOD FOR MANAGING ORGANIZATIONAL PARTICIPATION IN OBJECTIVE PURSUITS”, which is pending and which is incorporated by reference in its entirety for all purposes. This application also claims priority to Indian Patent Application No. 3548/CHE/2013 dated 7 Aug. 2013 and titled “SYSTEM AND METHOD FOR MANAGING ORGANIZATIONAL PARTICIPATION IN OBJECTIVE PURSUITS”, which claims priority from non-provisional U.S. patent application Ser. No. 13/609,899. This application claims priority to Indian Patent Application No. 3546/CHE/2013 dated 7 Aug. 2013 and titled “SYSTEM AND METHOD FOR KEEPING A RECORD OF OBJECTIVE PURSUITS”. This application claims priority to Indian Patent Application No. 3548/CHE/2013 dated 7 Aug. 2013 titled “SYSTEM AND METHOD FOR KEEPING A RECORD OF OBJECTIVE PURSUITS”.

U.S. patent application Ser. No. 13/609,899 filed on Sep. 2, 2012 titled “SYSTEM AND METHOD FOR MANAGING ORGANIZATIONAL PARTICIPATION IN OBJECTIVE PURSUITS” is a non-provisional counterpart to and claims priority to provisional U.S. Patent Application Ser. No. 61/672,470 filed on Jul. 17, 2012 titled “SYSTEM AND METHOD FOR MANAGING ORGANIZATIONAL PARTICIPATION IN OBJECTIVE PURSUITS”, incorporated by reference in its entirety for all purposes, and provisional U.S. Patent Application Ser. No. 61/696,182 filed on Sep. 2, 2012 titled “SYSTEM AND METHOD FOR MANAGING ORGANIZATIONAL PARTICIPATION IN OBJECTIVE PURSUITS”, which is incorporated by reference in its entirety for all purposes.

### FIELD OF INVENTION

The present invention is directed to a system and a method for managing organizational participation in an objective pursuit. More particularly the present invention is directed to a system and a method for managing organizational participation in objective pursuits by providing a mechanism to the individual to take and upload photographs that may include the identity of the individual.

### BACKGROUND OF INVENTION

Typically in any matter where a decision is to be made, individuals are involved; either when the individual is making a decision or a decision is being made on behalf of the individual. Invariably individuals making their decisions in the matter of organized pursuits feed from the vetted decisions of other individuals or their ecosystem if such information is available instead of researching anew. However in organizations as in companies, institutions, etc., traditional methods of organized pursuits are designed around large groups of individuals electing or selecting smaller groups of representatives and office bearers who take day to day decisions on behalf of all members of the organization. The basic merit of such a work structure is in the premise that it is not practical to poll or take inputs or opinions from all individual or constituent members, hence a representative model serves as an efficient proxy to run everyday business of large groups and public life. This work structure has a well-known and documented disadvantage of missing out on the collective opinion and wisdom of the individuals and learning from it as we design and execute public and large group policies and processes. Yet another method of polling may include a pre-mediated method where a questionnaire or a check-list may be provided and the individuals provide their inputs accordingly.

The technique involving statistical sampling based surveys may render a majority opinion but may leave the voices of the minority unheard just by sheer strength of the bargaining capacity of the majority “or due to sub-standard, incorrect, or incomplete sampling. The technique involving the representatives may include the prejudice and notions of the representatives in addition to that of the individuals and hence the inputs may be skewed. The technique involving the questionnaire or checklist may though provide inputs from every individual in a large group of individuals is based on tailor made set of questions and hence the resultant opinion does not arise out of the free will of the individuals. The disadvantages may often be corrected by using statistical sampling based surveys that give a sense on what constituents really want and how representative are the decisions taken by the organization, but it is apparent this sampling is also not based on input from all the individuals.

However, as individuals and groups become more and more interconnected, our problems acquire widespread national and international proportions in shorter and shorter intervals of time. As they touch individuals and groups from different cultures, with different challenges and with different priorities, our problems become more complex. The methods of obtaining inputs described hereinabove appear to be fast tending to being an obsolete practice as they are unable to keep abreast of the rising complexities resulting in delays in decision making. This translates into a need for an improved system and method for assisting organizations in taking informed decisions for organized pursuits based on the inputs of all the individuals in the group irrespective of the number of individuals in the group.

Individuals may be involved with a variety of objective pursuits at various levels. Their passion for the objective pursuits may be expressed in words or using photographs of the objective pursuits they may be involved in. However they may want to avoid unauthorized usage or distribution of the photographs by others.

Thus there is a need for a system and method to provide an individual with a mechanism to enable the individual to associate the identity of the individual with the photograph.

### SUMMARY OF INVENTION

In one embodiment, a system for managing organizational participation in an objective pursuit is provided. The system comprises a first local computer operated by an individual. A platform is provided for initiating an objective pursuit. The platform is capable of allowing the individual to initiate the objective pursuit of the individual's choice. The system further includes a central server in communication with the first local computer. The central server is capable of creating a database for the objective pursuit. The central server includes a governance loop capable of taking permission from the individual to propagate the objective pursuit. The system also provides a mechanism operated by the individual. The individual is capable of taking a photograph of the objective pursuits using the mechanism. The photographs may include details comprising identity of the individual. The individual is capable of uploading the photograph in the platform.

In another embodiment, a system for managing organizational participation in an objective pursuit is provided. The system comprises a first local computer operated by an individual. A platform is provided for including an objective pursuit. The platform is capable of allowing the individual to include the objective pursuit of the individual's choice. The system further includes a central server in communication with the first local computer. The central server is capable of creating a database for the objective pursuit. The central server includes a governance loop capable of taking permission from the individual to propagate the objective pursuit. The system also includes an objective pursuit ledger. The objective pursuit ledger keeps a record of the objective pursuits of the individual. The system also includes a mechanism operated by the individual. The individual is capable of taking a photograph of the objective pursuits using the mechanism. The photographs include details comprising identity of the individual. The individual is capable of uploading the photograph in the platform.

In yet another embodiment, a system for keeping a record of objective pursuits of an individual is provided. The system comprises a first local computer operated by an individual. A platform is provided for including an objective pursuit. The platform is capable of allowing the individual to include the objective pursuit of the individual's choice. The system further includes a central server in communication with the first local computer. The central server is capable of creating a database for the objective pursuit. The system also includes an objective pursuit ledger. The objective pursuit ledger keeps a record of the objective pursuits of the individual. The system also includes a mechanism operated by the individual. The individual is capable of taking a photograph of the objective pursuits using the mechanism. The photographs include details comprising identity of the individual. The individual is capable of uploading the photograph in the platform.

In still yet another embodiment, a method for managing organizational participation in an objective pursuit is provided. The method provides a first local computer. The first local computer is operated by an individual, A platform is provided for initiating an objective pursuit. The platform is capable of allowing the individual to initiate the objective pursuit of the individual's choice. The method further provides a central server in communication with the first local computer. The central server is capable of creating a database for the objective pursuit. The central server includes a governance loop capable of taking permission from the individual to propagate the objective pursuit. The method also provides a mechanism. The mechanism is operated by an individual. The individual is capable of taking a photograph of the objective pursuits using the mechanism. The photographs include details comprising identity of the individual. The individual is capable of uploading the photograph in the platform.

In still yet another embodiment, a method for managing organizational participation in an objective pursuit is provided. The method provides a first local computer. The first local computer is operated by an individual. A platform is provided for including an objective pursuit. The platform is capable of allowing the individual to include the objective pursuit of the individual's choice. The method further provides a central server in communication with the first local computer. The central server is capable of creating a database for the objective pursuit. The method further provides an objective pursuit ledger. The objective pursuit ledger keeps a record of the objective pursuits of the individual. The method also provides a mechanism. The mechanism is operated by the individual. The individual is capable of taking a photograph of the objective pursuits using the mechanism. The photographs comprise details comprising identity of the individual. The individual is capable of uploading the photograph in the platform.

In still yet another embodiment a method for keeping a record of objective pursuits of an individual is provided. The method provides a first local computer. The first local computer is operated by an individual. A platform is provided for including an objective pursuit. The platform is capable of allowing the individual to include the objective pursuit of the individual's choice. The method also provides a central server in communication with the first local computer system. The central server having a verification loop to verify the credentials of the individual. The central server is capable for creating a database for the objective pursuit. The central server has a governance loop capable of taking permission from the individual to propagate the objective pursuit. The system also provides an objective pursuit ledger. The objective pursuit ledger keeps a record of the objective pursuits of the individual. The objective pursuit ledger serves as a ready reckoner of the objective pursuits of the individual. The system further provides a mechanism operated by the individual. The individual is capable of taking a photograph of the objective pursuits using the mechanism. The photographs comprise details comprising identity of the individual. The individual is capable of uploading the photograph in the platform.

By using the above disclosed mechanism and employing the above disclosed system and method processes may be designed and built with the assumption that it may be possible for individuals and organizations to capture a visual individual identifiable photograph and keep a record of their objective pursuits or the objective pursuits of any organized group, no matter how large, on any issue, no matter how small, as long as the they may deem it valuable.

### BRIEF DESCRIPTION OF FIGURES

FIG. 1 is a schematic illustration representing a system for managing organizational participation in an objective pursuit in accordance with embodiments of the present disclosure;

FIG. 2 is a schematic illustration representing a system for managing organizational participation in an objective pursuit in accordance with embodiments of the present disclosure;

FIG. 3 is a schematic illustration representing a portion of a system for managing organizational participation in an objective pursuit in accordance with embodiments of the present disclosure;

FIG. 4 a schematic illustration representing a portion of a system for managing organizational participation in an objective pursuit in accordance with embodiments of the present disclosure;

FIG. 5 is a schematic illustration representing a portion of a system for managing organizational participation in an objective pursuit in accordance with embodiments of the present disclosure;

FIG. 6 is a schematic illustration representing an objective pursuit ledger in accordance with embodiments of the present disclosure;

FIG. 7 is a schematic illustration representing a system for keeping a record of objective pursuits of an individual in accordance with embodiments of the present disclosure;

FIG. 8 is a schematic illustration representing a system for managing organizational participation in an objective pursuit in accordance with embodiments of the present disclosure;

FIG. 9 is a schematic illustration representing a system for managing organizational participation in an objective pursuit in accordance with embodiments of the present disclosure; and

FIG. 10 is a schematic illustration representing a system for managing organizational participation in an objective pursuit in accordance with embodiments of the present disclosure.

### DETAILED DESCRIPTION

Embodiments of the invention as disclosed herein provide a system and method to provide an individual with a mechanism to enable the individual to associate the identity of the individual with the photograph of an objective pursuit. As individuals and groups become more and more interconnected, our problems acquire widespread national and international proportions in shorter and shorter intervals of time. As they touch individuals and groups from different cultures, with different challenges and with different priorities, our problems become more complex. The representative approach of governance and problem solving is clearly not able to keep pace with this complexity and speed. However the same interconnectedness of individuals and technologies that enable this now offer us an opportunity to build a next generation of solutions. As mentioned hereinabove it may not be a herculean task for an Individual to get involved at various levels in one or more than one objective pursuits. The difficult part may be to ensure that the involvement does not taper off. The interest of the individual may dwindle due to many reasons including lack of interest or motivation. This may be due to lack of time or lack of funds. Thus providing an individual with an objective pursuit ledger that is a ready reckoner of the objective pursuits that the individual is involved in may provide an incentive for the individual's continued involvement in the existing objective pursuits and new objective pursuits. The utility of the objective pursuit ledger may be extended to every individual who participates in the objective pursuits and also to organizations that take part in such objective pursuits. Visual representations are a better method of attracting the attention of individuals in addition to describing any matter in words. This may hold true in the case of objective pursuits where the photographs of the objective pursuits used by the individual may interest other individuals or corporates in getting involved. The individual while sharing the photographs may also want to ensure that the photographs associate the individual's involvement with the objective pursuit. The individual would want to curb any unauthorized use of the photographs by unauthorized individuals.

With the advent of internet and networking sites, many systems and methods are available and are proposed where individuals can share their inputs on their objective pursuits. However, since developments in technologies that enable interconnectedness are relatively recent, prior attempts of connecting individuals with similar objective pursuits have become possible only in the past year or so. Developments in technologies of online social networking including blogging, crowd sourcing are in their early stages, and adoption of these developments are largely by individuals and that too for basic needs like staying in touch with friends and family, chatting online and sharing pictures, videos, etc. Adoption of these by organizations and institutions is in very early stages. Most organizations use these technologies for product promotions, online listening, and internal online chatting among others. The companies that offer online social communities appear to largely target individuals and not organizations.

A primary advantage and function of the system and method disclosed herein is the ability to poll or take inputs or opinions from each member of a group of individuals before taking a decision to participate in an objective pursuit irrespective of the size of the group. In various embodiments, the system and method disclosed herein do so by taking concurrence from the individuals before propagating the objective pursuit to other individuals or to organizations and then taking concurrence from each such individual before propagating to other individuals and organizations. The system and method serve to bring together individuals or groups of individuals and organizations that may be otherwise following the same objective pursuit regardless of the others' participation thus making it beneficial for the organization, individual, and the objective pursuit. Additionally, the objective pursuit ledger, and a system and method of keeping record of objective pursuits of individuals or organizations serve to provide a motivation to the individual and the organizations. The system and method disclosed herein also provide an individual with a mechanism to enable the individual to associate the identity of the individual with the photograph of an objective pursuit.

The terminology used herein is for the purpose of describing particular exemplary embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. Terms such as “first,” “second,” and other numerical terms when used herein do not imply a sequence or order unless clearly indicated by the context. Thus, a first step or computer discussed below could be termed a second step or computer without departing from the teachings of the exemplary embodiments.

In various embodiments, the individual who initiates the objective pursuit may be referred to as a “creator”, the individual or group of individuals who then support the objective pursuit may be referred to as a “supporter” and the organization that elects to support the objective pursuit may be referred to as a “sponsor”. As used herein the phrase “objective pursuit” may alternatively be referred to as a “cause” in the specification or in the drawings.

In one embodiment, a system for managing organizational participation in an objective pursuit is provided. The system comprises a first local computer operated by an individual. A platform is provided for initiating an objective pursuit. The platform is capable of allowing the individual to initiate the objective pursuit of the individual's choice. The system further comprises a central server in communication with the first local computer. The central server is capable of creating a database for the objective pursuit. The central server comprises a governance loop capable of taking permission from the individual to propagate the objective pursuit.

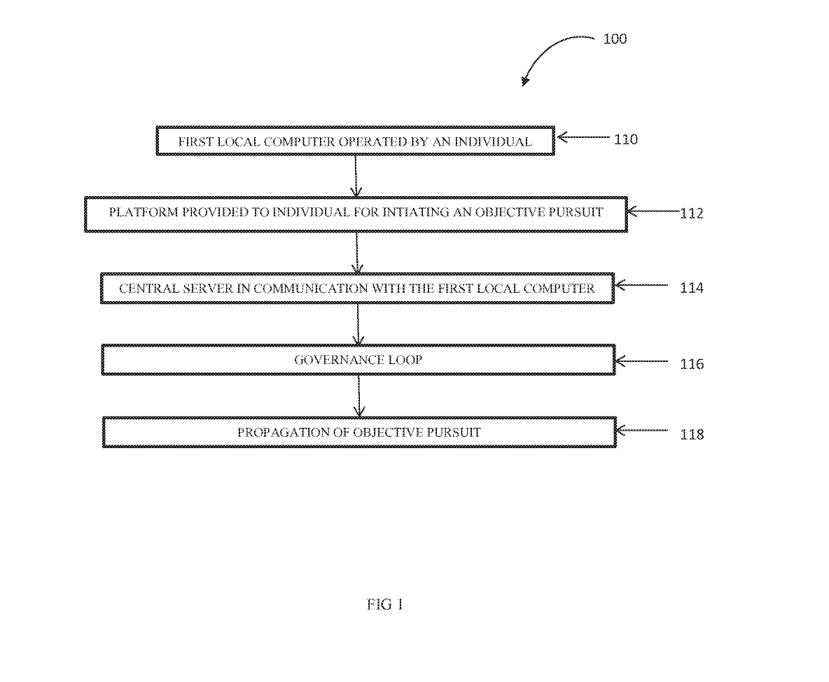

Referring to FIG. 1, a schematic illustration representing a system 100 for managing organizational participation in an objective pursuit in accordance with embodiments of the present disclosure is provided. The system 100 includes a first local computer operated by an individual 110. A platform is provided to the individual for initiating an objective pursuit 112 of the individual's choice. As used herein the phrase “individual's choice” means that there is no fixed list of objective pursuits or causes that an individual has to choose from. The individual has the flexibility to include an objective pursuit of the individual's choice. In one embodiment, the platform provided includes any suitable platform considered useful for this purpose by a person skilled in the art. Suitable examples of platforms may include but may not be limited to Facebook and LinkedIn. In one embodiment, the individual may be required to provide a title for the objective pursuit, a story or explanation on the objective pursuit, and optionally a photograph or photographs relevant to the objective pursuit. In certain other embodiments, the system may require the individual to provide other details as may be required from time to time to authenticate the information provided. The system further comprises a central server 114. In one embodiment, the central server is in communication with the first local computer. A person skilled in the art may determine the type of server that may be used as the central server, and the type of computer that may be employed as the local computer. The central server includes a governance loop 116. Using the governance loop the central server is capable of taking permission from the individual who initiates the objective pursuit to propagate the objective pursuit 118.

In another embodiment, a system for managing organizational participation in an objective pursuit is provided. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The system further comprises a second local computer system in communication with the central server operated by or on behalf of the organization, wherein the platform is provided for the organization to participate in the objective pursuit.

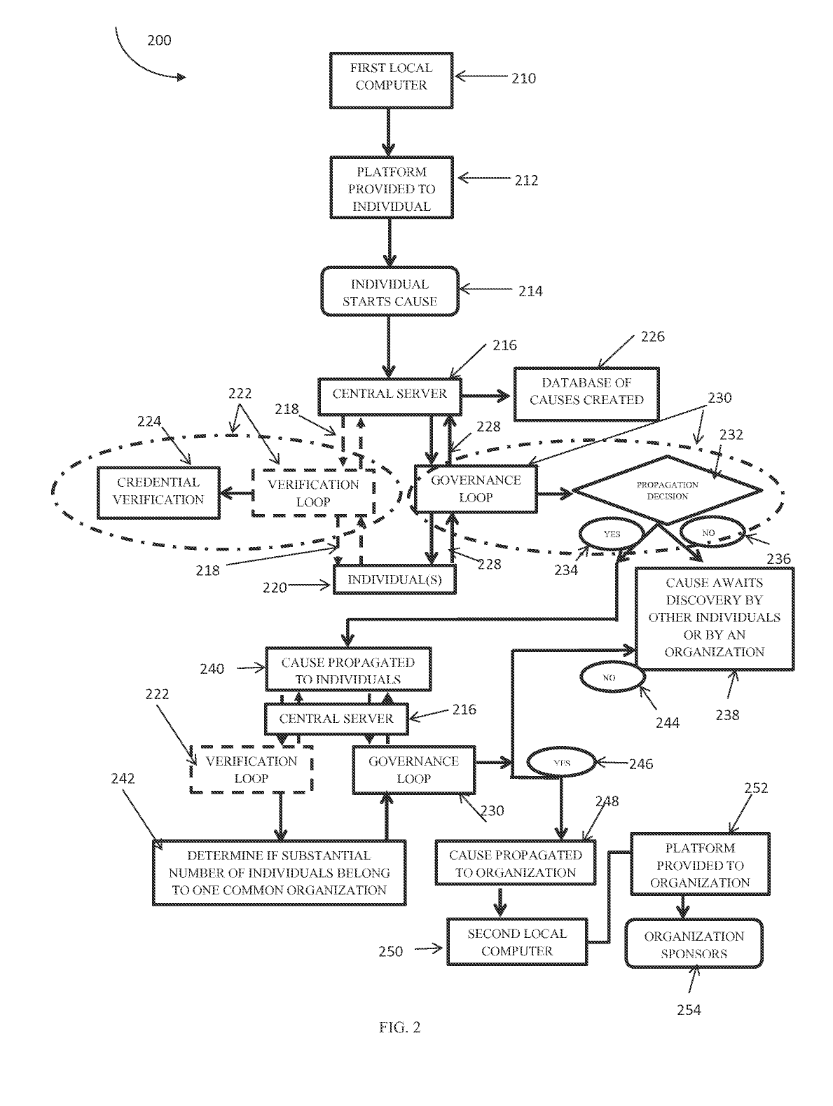

Referring to FIG. 2, a schematic illustration representing a system 200 for managing organizational participation in an objective pursuit in accordance with embodiments of the present disclosure is provided. The system 200 provides a first local computer 210. An individual 220 may use the first local computer 210 to access a platform provided to the individual 212. The individual can start 214 an objective pursuit i.e., a cause as referred to in FIG. 2 by using the platform 212 and the first local computer 210. A central server 216 is provided. The central server 216 is in communication with the first local computer 210. In one embodiment, once the individual initiates the cause the central server 216 initiates a to and fro communication 218 with the individual 220 using the first local computer 210. The to and fro communication 218 initiates an optional verification loop 222 to verify the credentials 224 of the individual 220. Once the credentials 224 are verified the central server 216 creates a database 226 of the causes or includes the cause in an existing database. In one embodiment, once the database is created the central server 216 initiates a to and fro communication 228 with the individual 220 using the first local computer 210. The to and fro communication 228 initiates a governance loop 230. The governance loop 230 gives the individual 220 an opportunity to make a propagation decision 232. If the individual 220 gives a negative indication 236 i.e., “NO”, then the cause remains in the database 226 waiting to be discovered by others who may browse through the database. If the individual provides a negative indication 236 the system 200 does not actively attempt to propagate the cause to other individuals available in the social network of the individual 220 who created the cause. The cause may remain on the database waiting for others to discover it. On the other hand if the individual 220 gives a positive indication 234 the cause may be actively propagated by the central server 216 to a group of other individuals 240. The other individuals in their turn use a local computer or other suitable mechanism (not shown in figure) to support the cause and thus become supporters of the cause. In one embodiment, the central server 216 may allow the other individuals 240 to support the cause only after initiating and completing a verification loop 222 with each member in the group of other individuals. Once the verification loop 222 is completed the central server may ascertain information i.e., determine if a substantial number of individuals belong to one organization 242. The central server 216 initiating the governance loop 230 with each of the other individuals in the group of other individuals 240. For each individual of the group who gives a negative indication 244, the cause stays in the database created 238 waiting to be discovered. In one embodiment, for each individual of the group who gives a positive indication 246 the cause may be further propagated to other individuals in the social network of each of these individuals (not shown in figure). In another embodiment, for each individual of the group who gives a positive indication 246, and if it is determined that a substantial number of the individuals belong to one organization 242 then the cause is propagated to such an organization 248. The organization 248 may use a second local computer 250 and use a platform provided 252 and support or sponsor the cause 254. Thus there is no automatic or self, propagation of the cause once the cause is created without initiating the governance loop and taking permission from the creator and subsequently the supporters. In certain embodiments, (not shown in figure), if an individual starts a cause the central server may determine after having followed the verification loop that the individual belongs to an organization that supports the cause. The central server may then initiate the governance loop with the individual and seek permission from the individual to take organizational support for this cause. In one embodiment, if the individual gives a negative indication then the central server will not proceed with informing the individual of the organization's participation in the cause. In another embodiment, if the individual gives a positive indication then the central server will proceed with informing the individual of the organization's participation. The individual and the organization may then use their local computers and their platforms to together participate in the cause.

In yet another embodiment, a system for managing organizational participation in an objective pursuit is provided. The system comprises a first local computer system operated by an individual, wherein a platform is provided for initiating an objective pursuit, wherein the platform is capable of allowing the individual to initiate the objective pursuit of the individual's choice. The system further comprise a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of ascertaining information that an organization is supporting this objective pursuit and that the individual is connected with the organization. The central server is capable of informing the individual of the involvement of the organization in the objective pursuit. The system further comprises a second local computer system in communication with the central server operated by or on behalf of the organization, wherein the platform is provided for the organization and individual to participate together in the objective pursuit.

In yet another embodiment, a system for managing organizational participation in an objective pursuit is provided. The system comprises a first local computer system operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The system further comprises a second local computer system in communication with the central server operated by or on behalf of the organization, wherein the platform is provided for the organization to participate in the objective pursuit.

In still yet another embodiment, a system for managing organizational participation in an objective pursuit is provided. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The system further comprises a second local computer in communication with the central server operated by or on behalf of the organization, wherein the platform is provided for the organization to participate in the objective pursuit.

In one embodiment, the individual who creates the cause may also be provided with a platform that allows the individual to choose the kind of support the individual expects from peers. For example, the individual may choose any one of the following support from peers i.e., be a volunteer, pledge fund, sign a petition, or simply vote for the cause. The individual is also provided with an option to classify or bucket the cause, i.e., the individual may classify the cause under human rights, education, etc.

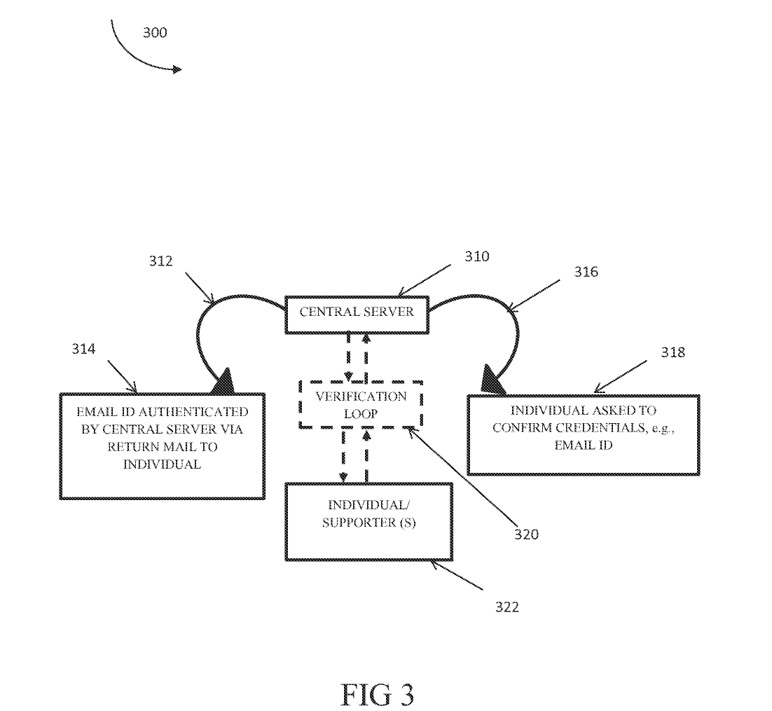

Referring to FIG. 3, a schematic illustration representing a portion 300 of system for managing organizational participation in an objective pursuit in accordance with embodiments of the present disclosure is provided. The portion 300 shows the verification loop initiated by the central server 310 to verify every individual 322 who creates or supports a cause. The central server 310 may initiate a verification loop 320. The verification loop 320 includes a first step 312 of the central server 310 sending a return electronic mail 314 to the individual. This is to verify the authenticity of the individual's electronic mail information and other credentials provided by the individual 322 while creating or supporting the cause. The verification message may request 316 the individual to confirm 318 their electronic mail identification and other credentials by responding to the return electronic mail. In one embodiment, the central server may require the individual to provide an official electronic mail identification as one of the purposes of this invention is to assist an organization to employ the social discovery process before sponsoring any objective pursuit.

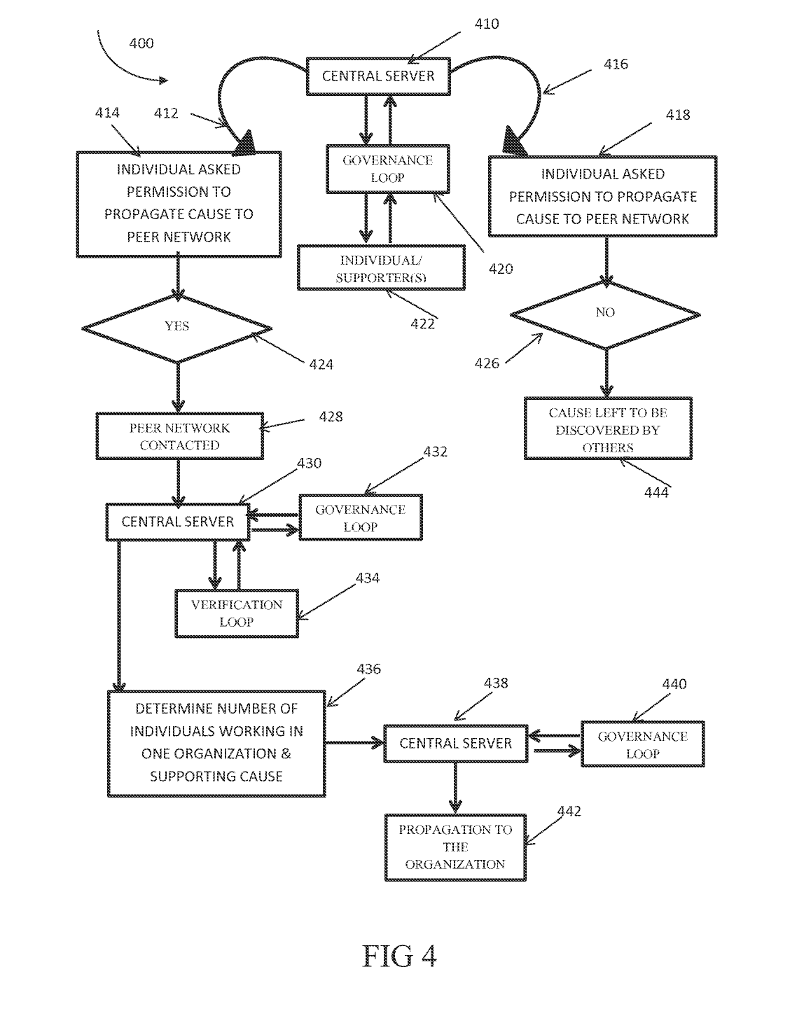

Referring to FIG. 4, a schematic illustration representing a portion 400 of system for managing organizational participation in an objective pursuit in accordance with embodiments of the present disclosure is provided. In one embodiment, the portion 400 shows the governance 420 loop initiated by the central server 410 to take permission 412 from very individual who creates 422 a cause to propagate the cause to other individuals in the peer network 414 or social network of the individual. This individual may be called as the creator of the cause or objective pursuit. If a positive indication 424 i.e., “YES”, is obtained from the individual then the peer network is contacted and the database formed by the central server (not shown in figure, as discussed herein above) is made viewable to the peer network. The central server 430 now communicates with each individual from the peer network and initiates the verification loop 434 as discussed in FIG. 3 and the governance loop 432 as discussed in FIG. 4. The verification loop 434 verifies the credentials of each individual from the peer network. During the verification procedure the central server may accept the non-official electronic mail identification of the individual. The governance loop 432 is initiated to take permission from each individual from the peer network to propagate the cause to their peer network (not shown in figure). While proceeding with the governance loop the central server may require the individual to provide official electronic mail identification as this information is then later used to determine the number of individuals that belong to one common organization and are supporting one common objective pursuit as described herein below. The verification loop and governance loop is thus initiated not only with the creator of the cause but also with each individual who supports the cause. In another embodiment, the central server analyses the electronic mail identification (i.e., official electronic mail identification) provided by individuals as a result of the verification loop and determines 436 that a substantial number of the individuals are working in one common organization. In one embodiment, the creator and supporter may belong to the same organization. In another embodiment, the creator and supporter may belong to different organizations. The central server 438 again initiates the governance loop 440 with each individual and requests permission to propagate the cause to the organization 442. Thus the current disclosure is advantageous in that at each step every individual involved either in the role of a creator or a supporter is given an option to provide permission for further propagation of the cause. Accordingly, an organization derives benefits from a combined vote or poll of each individual who is a part of the cause and not just from a majority number of individuals who may be part of the cause.

In still yet another embodiment, a system for managing organizational participation in an objective pursuit is provided. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The system further comprises a second local computer in communication with the central server operated by or on behalf of the organization, wherein the platform is provided for the organization to participate in the objective pursuit.

In still yet another embodiment, a system for managing organizational participation in an objective pursuit is provided. The system comprises a first local computer system operated by an individual, wherein a platform is provided for initiating an objective pursuit, wherein the platform is capable of allowing the individual to initiate the objective pursuit of the individual's choice. The system further comprise a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The system further comprises a second local computer operated by or on behalf of an organization, wherein the platform is provided for the organization to evaluate the database for objective pursuits. The organization elects to support at least one objective pursuit from the database for the objective pursuits. The central server is capable of informing the individual of the organization's election of supporting the objective pursuit. The central server reinitiates the governance loop to enable the individual to either accept or decline the organization's support. The individual accepts or declines the organization's support using the first local computer system operated by the individual.

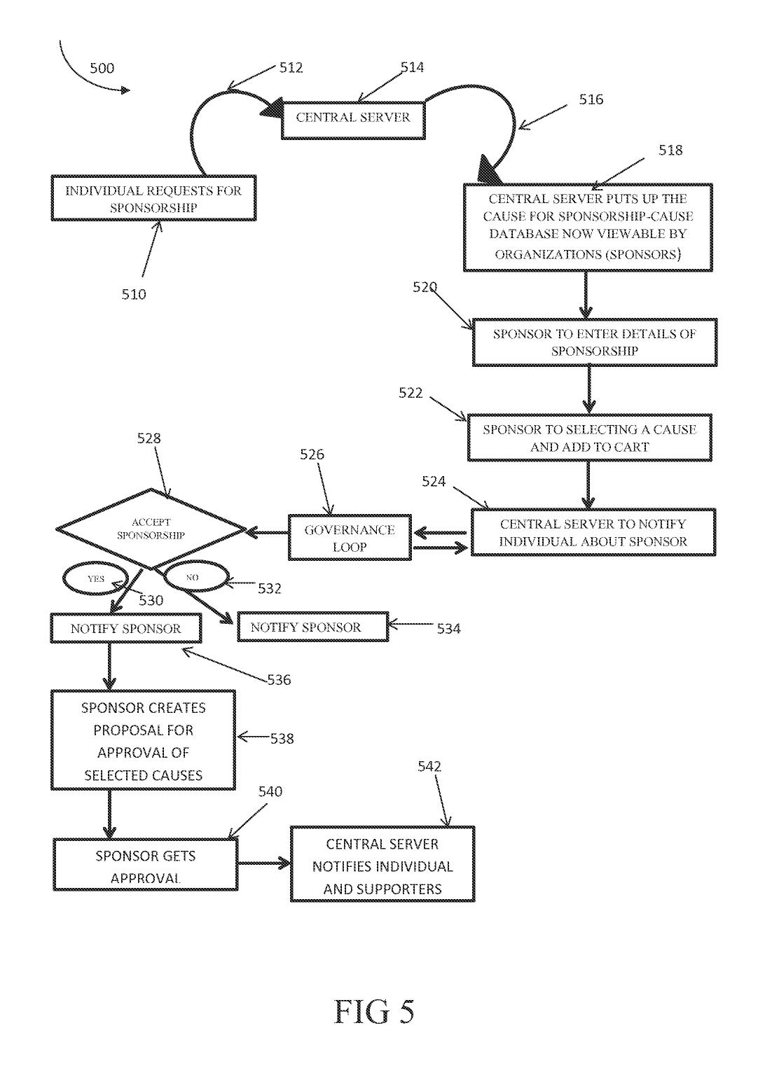

Referring to FIG. 5, a schematic illustration representing a portion 500 of a system for managing organizational participation in an objective pursuit in accordance with embodiments of the present disclosure is provided. In the platform (discussed herein above, not shown in FIG. 5) an individual is given an option to request sponsorship 510 for a cause. The request is forwarded 512 to the central server 514. The central server 512 opens up the cause 516 for sponsorship and the cause database is then rendered viewable by organizations 518. The organization is then provided a platform to enter details of the sponsorship 520 in a second local computer (not shown in figure). In various embodiments the details may include the story behind why the organization would like to sponsor the cause, if the organization is sponsoring any such similar cause, if the organization is aware that any of their employee supports the cause, and the like. The organization then selects the cause and adds to a cart 522. The central server then initiates a governance loop 526 by notifying the individual who created the cause about the organization 524. The individual is then provided with a decision box 528 on whether to provide a positive indication or negative indication to the sponsorship. If the individual provides a negative indication 532 the organization is notified 534 and the cause is not propagated any further by the central server to the organization in question. If the individual provides a positive indication 530, the organization is notified 536. The organization may then create a proposal to get approval for the cause 538 and get approval for sponsoring the cause 540. The creator and supporters are then notified about the approval 542. The creator may be provided the rights to make a final approval using decision box 528, though each supporter may be provided with a right to give an approval. For example, if the cause is in favour of “No Smoking” the creator may provide a negative indication to accept support from an organization manufacturing cigarettes. However one of the supporters may provide a positive indication for accepting sponsorship. In this example, the creator's decision holds more power than that of the supporter and the organization is notified that the sponsorship has been rejected by the creator.

In one embodiment, an objective pursuit ledger is provided. The ledger comprises a system for managing participation in an objective pursuit. The system comprises a first local computer operated by an individual. A platform is provided in the first local computer for including an objective pursuit. The platform is capable of allowing the individual to include the objective pursuit of the individual's choice. The system also comprises a central server in communication with the first local computer. The central server is capable of creating a database for the objective pursuit. The objective pursuit ledger keeps a record of the objective pursuits of the individual. The objective pursuit ledger serves as a ready reckoner of the objective pursuits of the individual.

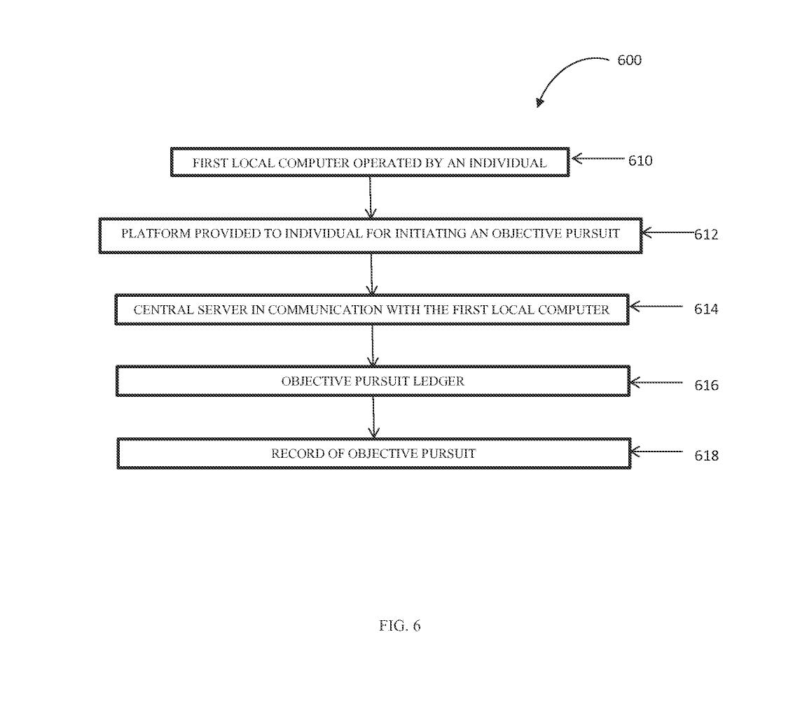

Referring to FIG. 6, a schematic illustration representing a system 600 for managing organizational participation in an objective pursuit in accordance with embodiments of the present disclosure is provided. The system 600 includes a first local computer operated by an individual 610. A platform is provided to the individual for initiating an objective pursuit 612 of the individual's choice. The system further comprises a central server 614. In one embodiment, the central server is in communication with the first local computer. The central server includes an objective pursuit ledger 616. The objective pursuit ledger is capable of keeping record of the objective pursuits of the individual 618.

In another embodiment, a system for keeping a record of objective pursuits of an individual is provided. The system comprises a first local computer operated by an individual. A platform is provided in the first local computer for including an objective pursuit. The platform is capable of allowing the individual to include the objective pursuit of the individual's choice. The system also comprises a central server in communication with the first local computer system. The central server has a verification loop to verify the credentials of the individual. The central server is capable for creating a database for the objective pursuit. The central server has a governance loop capable of taking permission from the individual to propagate the objective pursuit. The system includes an objective pursuit ledger. The objective pursuit ledger keeps a record of the objective pursuits of the individual. The objective pursuit ledger serves as a ready reckoner of the objective pursuits of the individual.

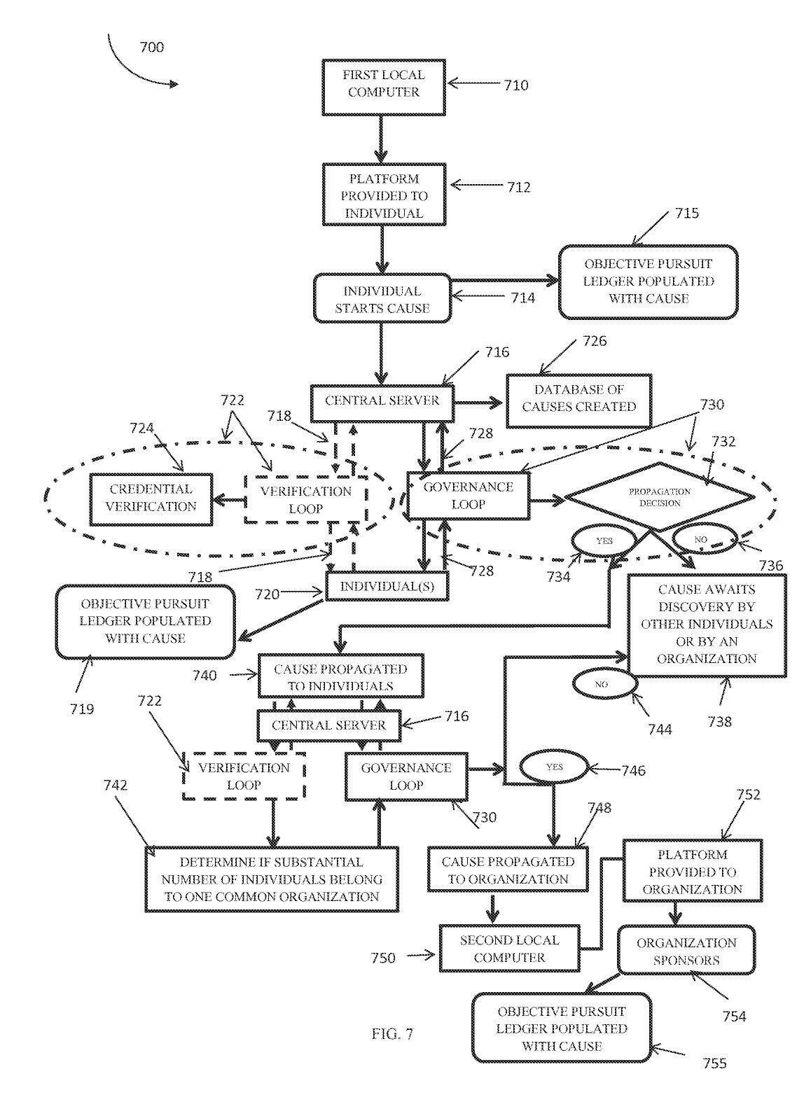

Referring to FIG. 7, a schematic illustration representing a system 700 for managing organizational participation in an objective pursuit in accordance with embodiments of the present disclosure is provided. The system 700 provides a first local computer 710. An individual 720 may use the first local computer 710 to access a platform provided to the individual 712. The individual can start 714 an objective pursuit i.e., a cause as referred to in FIG. 7 by using the platform 712 and the first local computer 710. A central server 716 is provided. The central server 716 is in communication with the first local computer 710. In one embodiment, once the individual initiates the cause 714 the objective pursuit ledger 715 is populated with the cause and makes a record of the cause involved in by the individual. Once the individual initiates the cause 714 the central server 716 initiates a to and fro communication 718 with the individual 720 using the first local computer 710. The to and fro communication 718 initiates an optional verification loop 722 to verify the credentials 724 of the individual 720. Once the credentials 724 are verified the central server 716 creates a database 726 of the causes or includes the cause in an existing database. In one embodiment, once the database is created the central server 716 initiates a to and fro communication 728 with the individual 720 using the first local computer 710. The to and fro communication 728 initiates a governance loop 730. The governance loop 730 gives the individual 720 an opportunity to make a propagation decision 732. If the individual 720 gives a negative indication 736 i.e., “NO”, then the cause remains in the database 726 waiting to be discovered by others who may browse through the database. If the individual provides a negative indication 736 the system 700 does not actively attempt to propagate the cause to other individuals 720 available in the social network of the individual 720 who created the cause. The cause may remain on the database waiting for others to discover it. On the other hand if the individual 720 gives a positive indication 734 the cause may be actively propagated by the central server 716 to a group of other individuals 740. The other individuals 720 in their turn use a local computer or other suitable mechanism (not shown in figure) to support the cause and thus become supporters of the cause. In one embodiment, the central server 716 may allow the other individuals 740 to support the cause only after initiating and completing a verification loop 722 with each member in the group of other individuals. Once the other individual 720 gets involved in the cause, the objective pursuit ledger 719 of the other individual 720 keeps a record of the objective pursuits involved in by the other individual 720. Once the verification loop 722 is completed the central server may ascertain information i.e., determine if a substantial number of individuals belong to one organization 742. The central server 716 initiating the governance loop 730 with each of the other individuals in the group of other individuals 740. For each individual of the group who gives a negative indication 744, the cause stays in the database created 738 waiting to be discovered. In one embodiment, for each individual of the group who gives a positive indication 746 the cause may be further propagated to other individuals in the social network of each of these individuals (not shown in figure). In another embodiment, for each individual of the group who gives a positive indication 746, and if it is determined that a substantial number of the individuals belong to one organization 742, then the cause is propagated to such organization 748. The organization 748 may use a second local computer 750 and use a platform provided 752 and support or sponsor the cause 754. Once the organization 748 gets involved in the cause, the objective pursuit ledger 755 of the organization 748 keeps a record of the objective pursuits involved in by the organization 748. Thus there is no automatic or self, propagation of the cause once the cause is created without initiating the governance loop and taking permission from the creator and subsequently the supporters. In certain embodiments. (not shown in figure), if an individual starts a cause the central server may determine after having followed the verification loop that the individual belongs to an organization that supports the cause. The central server may then initiate the governance loop with the individual and seek permission from the individual to take organizational support for this cause. In one embodiment, if the individual gives a negative indication then the central server will not proceed with informing the individual of the organization's participation in the cause. In another embodiment, if the individual gives a positive indication then the central server will proceed with informing the individual of the organization's participation. The individual and the organization may then use their local computers and their platforms to together participate in the cause.

In various embodiments, the objective pursuit ledger may allow the individual to maintain the record of the objective pursuits in an offline mode or online mode. In one embodiment, in an offline mode the system may direct the individual to enter the involvement with objective pursuits in a physical ledger like a diary or a book. In another embodiment, in an offline mode the system may direct the individual to enter the involvement with objective pursuits in the first local computer system in any compatible manner as known to one skilled in the art. In one embodiment, in an online mode the central server may directly pass on the information of the individual's involvement with objective pursuits to the objective pursuit ledger or in another embodiment, the central server may direct the individual to enter the information in the objective pursuit ledger. Thus an individual is provided with a flexibility to maintain a record of the individual's objective pursuits in a manner most convenient to the individual.

In one embodiment, a system for managing organizational participation in an objective pursuit is provided. The system comprises a first local computer operated by an individual. A platform is provided for initiating an objective pursuit. The platform is capable of allowing the individual to initiate the objective pursuit of the individual's choice. The system further includes a central server in communication with the first local computer. The central server is capable of creating a database for the objective pursuit. The central server includes a governance loop capable of taking permission from the individual to propagate the objective pursuit. The system also provides a mechanism operated by the individual. The individual is capable of taking a photograph of the objective pursuits using the mechanism. The photographs may include details comprising identity of the individual. The individual is capable of uploading the photograph in the platform.

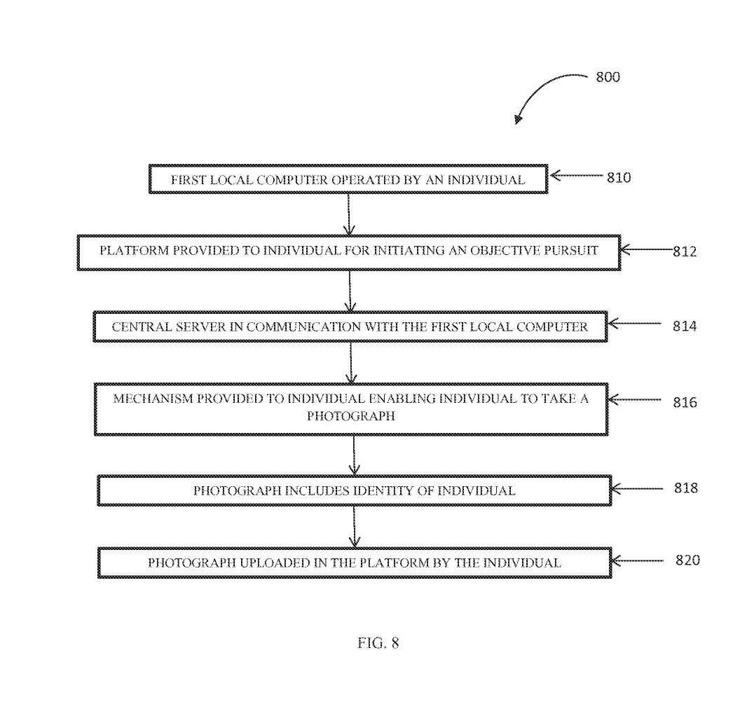

Referring to FIG. 8, a schematic illustration representing a system 800 for managing organizational participation in an objective pursuit in accordance with embodiments of the present disclosure is provided. The system 800 includes a first local computer operated by an individual 810. A platform is provided to the individual for initiating an objective pursuit 812 of the individual's choice. The system further comprises a central server 814. In one embodiment, the central server is in communication with the first local computer. A mechanism is provided to the individual enabling the individual to take a photograph 818. The individual may upload the photograph in the platform 820.

In another embodiment, a system for managing organizational participation in an objective pursuit is provided. The system comprises a first local computer operated by an individual. A platform is provided for including an objective pursuit. The platform is capable of allowing the individual to include the objective pursuit of the individual's choice. The system further includes a central server in communication with the first local computer. The central server is capable of creating a database for the objective pursuit. The central server includes a governance loop capable of taking permission from the individual to propagate the objective pursuit. The system also includes an objective pursuit ledger. The objective pursuit ledger keeps a record of the objective pursuits of the individual. The system also includes a mechanism operated by the individual. The individual is capable of taking a photograph of the objective pursuits using the mechanism. The photographs include details comprising identity of the individual. The individual is capable of uploading the photograph in the platform.

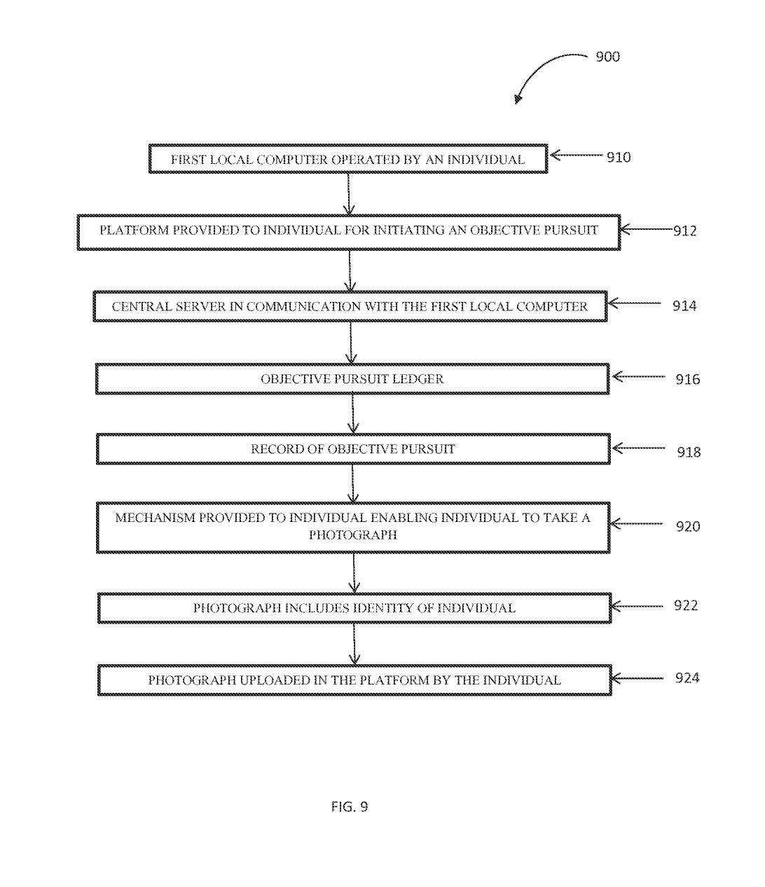

Referring to FIG. 9, a schematic illustration representing a system 900 for managing organizational participation in an objective pursuit in accordance with embodiments of the present disclosure is provided. The system 900 includes a first local computer operated by an individual 910. A platform is provided to the individual for initiating an objective pursuit 912 of the individual's choice. The system further comprises a central server 914. In one embodiment, the central server is in communication with the first local computer. The central server includes an objective pursuit ledger 916. The objective pursuit ledger is capable of keeping record of the objective pursuits of the individual 918. A mechanism is provided to the individual enabling the individual to take a photograph 920. The photograph includes the identity of the individual 922. The individual may upload the photograph in the platform 924.

In yet another embodiment, a system for keeping a record of objective pursuits of an individual is provided. The system comprises a first local computer operated by an individual. A platform is provided for including an objective pursuit. The platform is capable of allowing the individual to include the objective pursuit of the individual's choice. The system further includes a central server in communication with the first local computer. The central server is capable of creating a database for the objective pursuit. The system also includes an objective pursuit ledger. The objective pursuit ledger keeps a record of the objective pursuits of the individual. The system also includes a mechanism operated by the individual. The individual is capable of taking a photograph of the objective pursuits using the mechanism. The photographs include details comprising identity of the individual. The individual is capable of uploading the photograph in the platform.

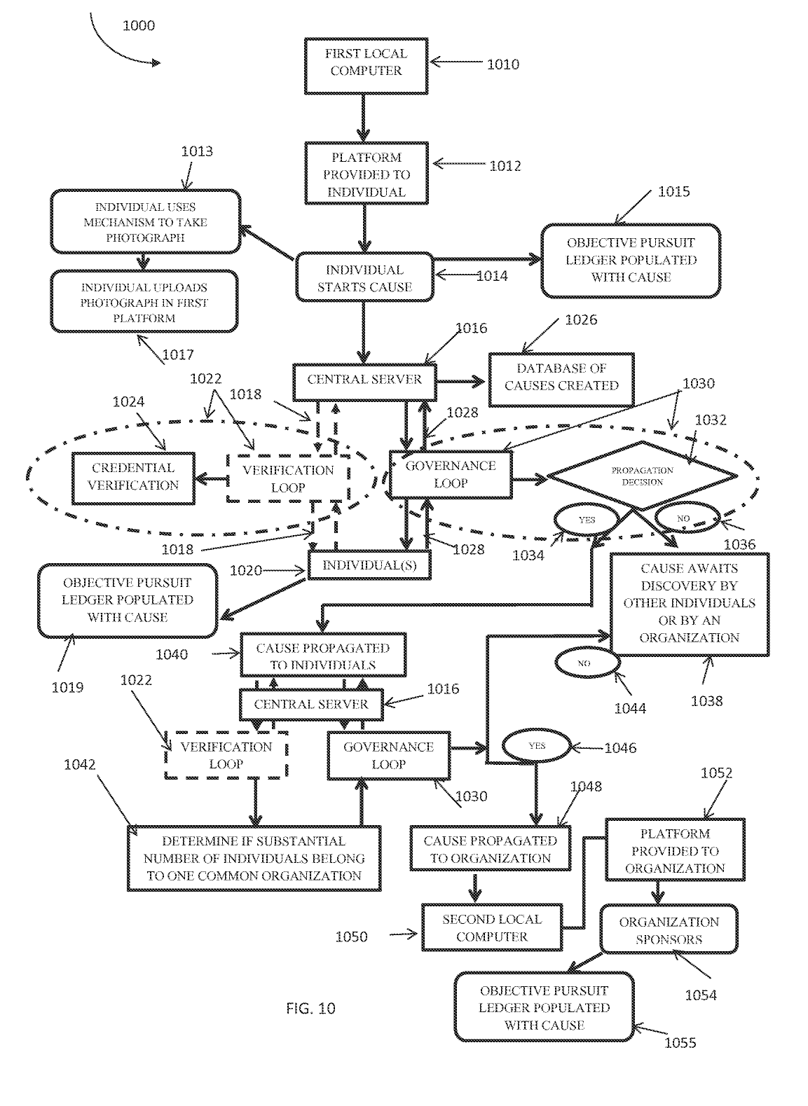

Referring to FIG. 10, a schematic illustration representing a system 1000 for managing organizational participation in an objective pursuit in accordance with embodiments of the present disclosure is provided. The system 1000 provides a first local computer 1010. An individual 1020 may use the first local computer 1010 to access a platform provided to the individual 1012. The individual can start 1014 an objective pursuit i.e., a cause as referred to in FIG. 10 by using the platform 1012 and the first local computer 1010. The individual may also be provided with a mechanism to take a photograph of the objective pursuit 1013. The individual may upload the photograph in the first platform 1017. In various embodiments, the details included in the photograph may include identity of the individual, location where the photograph is taken, time where the photograph is taken, type of the objective pursuit, type of the objective pursuit, motivation for the objective pursuit, number of individuals involved in the objective pursuit, involvement of any corporate in the objective pursuit, and beneficiaries of the objective pursuit. In one embodiment these details may be included in the photographs by methods known to one skilled in the art. In one embodiment, the details may be included in a digitized manner that may be invisible to the viewer but detectable using appropriate software. In one embodiment, the mechanism provided include a device comprising a software application that enables the device to capture a photograph and attach the details comprising identity of the individual to the photograph. In various embodiments, the device may include but are not limited to handheld devices like mobile phone, a digital camera, a tablet personal computer, a wearable device like a watch, glasses, etc., and a laptop. One skilled in the art will appreciate that any appropriate software and any appropriate device may be employed to take and upload the photographs in the first local computer 1010 using the platform 1012 by an individual. A central server 1016 is provided. The central server 1016 is in communication with the first local computer 1010. In one embodiment, once the individual initiates the cause 1014 the objective pursuit ledger 1015 is populated with the cause and makes a record of the cause involved in by the individual. Once the individual initiates the cause 1014 the central server 1016 initiates a to and fro communication 1018 with the individual 1020 using the first local computer 1010. The to and fro communication 1018 initiates an optional verification loop 1022 to verify the credentials 1024 of the individual 1020. Once the credentials 1024 are verified the central server 1016 creates a database 1026 of the causes or includes the cause in an existing database. In one embodiment, once the database is created the central server 1016 initiates a to and fro communication 1028 with the individual 1020 using the first local computer 1010. The to and fro communication 1028 initiates a governance loop 1030. The governance loop 1030 gives the individual 1020 an opportunity to make a propagation decision 1032. If the individual 1020 gives a negative indication 1036 i.e., “NO”, then the cause remains in the database 1026 waiting to be discovered by others who may browse through the database. If the individual provides a negative indication 1036 the system 1000 does not actively attempt to propagate the cause to other individuals 1020 available in the social network of the individual 1020 who created the cause. The cause may remain on the database waiting for others to discover it. On the other hand if the individual 1020 gives a positive indication 1034 the cause may be actively propagated by the central server 1016 to a group of other individuals 1040. The other individuals 1020 in their turn use a local computer or other suitable mechanism (not shown in figure) to support the cause and thus become supporters of the cause. In one embodiment, the central server 1016 may allow the other individuals 1040 to support the cause only after initiating and completing a verification loop 1022 with each member in the group of other individuals. Once the other individual 1020 gets involved in the cause, the objective pursuit ledger 1019 of the other individual 1020 keeps a record of the objective pursuits involved in by the other individual 1020. Once the verification loop 1022 is completed the central server may ascertain information i.e., determine if a substantial number of individuals belong to one organization 1042. The central server 1016 initiating the governance loop 1030 with each of the other individuals in the group of other individuals 1040. For each individual of the group who gives a negative indication 1044, the cause stays in the database created 1038 waiting to be discovered. In one embodiment, for each individual of the group who gives a positive indication 1046 the cause may be further propagated to other individuals in the social network of each of these individuals (not shown in figure). In another embodiment, for each individual of the group who gives a positive indication 1046, and if it is determined that a substantial number of the individuals belong to one organization 1042, then the cause is propagated to such organization 1048. The organization 1048 may use a second local computer 1050 and use a platform provided 1052 and support or sponsor the cause 1054. Once the organization 1048 gets involved in the cause, the objective pursuit ledger 1055 of the organization 1048 keeps a record of the objective pursuits involved in by the organization 1048. Thus there is no automatic or self, propagation of the cause once the cause is created without initiating the governance loop and taking permission from the creator and subsequently the supporters. In certain embodiments, (not shown in figure), if an individual starts a cause the central server may determine after having followed the verification loop that the individual belongs to an organization that supports the cause. The central server may then initiate the governance loop with the individual and seek permission from the individual to take organizational support for this cause. In one embodiment, if the individual gives a negative indication then the central server will not proceed with informing the individual of the organization's participation in the cause. In another embodiment, if the individual gives a positive indication then the central server will proceed with informing the individual of the organization's participation. The individual and the organization may then use their local computers and their platforms to together participate in the cause.

In still yet another embodiment, a method for managing organizational participation in an objective pursuit is provided. The method provides a first local computer. The first local computer is operated by an individual. A platform is provided for initiating an objective pursuit. The platform is capable of allowing the individual to initiate the objective pursuit of the individual's choice. The method further provides a central server in communication with the first local computer. The central server is capable of creating a database for the objective pursuit. The central server includes a governance loop capable of taking permission from the individual to propagate the objective pursuit. The method also provides a mechanism. The mechanism is operated by an individual. The individual is capable of taking a photograph of the objective pursuits using the mechanism. The photographs include details comprising identity of the individual. The individual is capable of uploading the photograph in the platform.

In still yet another embodiment, a method for managing organizational participation in an objective pursuit is provided. The method provides a first local computer. The first local computer is operated by an individual. A platform is provided for including an objective pursuit. The platform is capable of allowing the individual to include the objective pursuit of the individual's choice. The method further provides a central server in communication with the first local computer. The central server is capable of creating a database for the objective pursuit. The method further provides an objective pursuit ledger. The objective pursuit ledger keeps a record of the objective pursuits of the individual. The method also provides a mechanism. The mechanism is operated by the individual. The individual is capable of taking a photograph of the objective pursuits using the mechanism. The photographs comprise details comprising identity of the individual. The individual is capable of uploading the photograph in the platform.

In still yet another embodiment a method for keeping a record of objective pursuits of an individual is provided. The method provides a first local computer. The first local computer is operated by an individual. A platform is provided for including an objective pursuit. The platform is capable of allowing the individual to include the objective pursuit of the individual's choice. The method also provides a central server in communication with the first local computer system. The central server having a verification loop to verify the credentials of the individual. The central server is capable for creating a database for the objective pursuit. The central server has a governance loop capable of taking permission from the individual to propagate the objective pursuit. The system also provides an objective pursuit ledger. The objective pursuit ledger keeps a record of the objective pursuits of the individual. The objective pursuit ledger serves as a ready reckoner of the objective pursuits of the individual. The system further provides a mechanism operated by the individual. The individual is capable of taking a photograph of the objective pursuits using the mechanism. The photographs comprise details comprising identity of the individual. The individual is capable of uploading the photograph in the platform.

In one embodiment, the individual who creates the cause may also be provided with a platform that allows the individual to choose the kind of support the individual expects from peers. For example, the individual may choose any one of the following support from peers i.e., be a volunteer, pledge fund, sign a petition, or simply vote for the cause. The individual is also provided with an option to classify or bucket the cause, i.e., the individual may classify the cause under human rights, education, etc. Accordingly the objective cause ledger may provide a record of any kind of support provided by the individuals or the organization. The objective pursuits may include different levels of participation by the individual including those that are initiated by, supported by, and actively participated in by the individual.

Suitable examples of objective pursuits may include but are not limited to social causes, subject matter related to policy making, information sharing, recruitment, referral of employees, and maintaining employee satisfaction. For example, let us consider an online social networking based system. The system allows corporations and institutions to connect with an individual's passion for social and environmental causes through a social discovery method. As used herein, the phrase “social discovery method” refers to the age old method of checking with relatives, friends, acquaintances and reliable sources before taking any decision, for example donating for a tsunami cause. Organizations in their turn feed off the information available with their employees who participate in such social and environmental causes. Organizations can then support these causes through a safe and socially verifiable method. The social discovery process and the socially verifiable support method are very powerful in solving several problems that we face in human organizations. Examples of such human organizations include but are not limited to communities, workplaces, schools, governments and not-for-profit organizations. In one embodiment, the objective pursuits discussed herein are generally acts of goodness and good will. In one embodiment, the objective pursuit includes an act of volunteering. Suitable examples of the act of volunteering may include but are not limited to undertaking an act of teaching in a school, painting a school, and giving monetary or other donations to a school.

In various embodiments the record of the objective pursuits may be translated into different kinds of rewards. The rewards may depend upon the level of participation by the individuals as described herein above. The rewards may include points, cash incentives, discounts, and meet with celebrities among other rewards. In certain embodiments, the system and method included herein may also provide tradability of the rewards using the objective pursuit ledger. For example, tradability may be achieved by using rewards including bit-coins, or objective pursuit credits, and similar methods as known to a person skilled in the art.

In one embodiment, the objective pursuit ledger provided by the system enables an individual to possess a universal profile. The universal profile may include any objective pursuit included by the individual from any location, directly, through another individual, through an organization, individually, collectively in a group, by donating cash, and by donating time. The universal profile of the individual may then be employed to identify an individual with a personal social responsibility activity (PSRA) that can be utilised in favour of the individual as a personal social responsibility product (PSRP). In today's day when there is a lot of talk of involvement of individuals and organizations in objective pursuits the PSRP identifies the individuals based on their universal profile and PSRA.

In still yet another embodiment, a method for managing organizational participation in an objective pursuit is provided. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer, the central server having a verification loop to verify the credentials of the individual, wherein the central server is capable of creating a database for the objective pursuit. The central server includes a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The method further comprises a step of providing a second local computer in communication with the central server to be operated by or on behalf of the organization, wherein the platform is provided for the organization to participate in the objective pursuit.

In still yet another embodiment, a method for managing organizational participation in an objective pursuit is provided. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer, the central server having a verification loop to verify the credentials of the individual, wherein the central server is capable of creating a database for the objective pursuit. The central server having a governance loop capable of taking permission from the individual to propagate the objective pursuit. The central server is capable of ascertaining information that an organization is supporting this objective pursuit and that the individual is connected with the organization. The central server is capable of informing the individual of the involvement of the organization in the objective pursuit. The method further comprises a step of providing a second local computer operated by or on behalf of the organization, wherein the platform is provided for the organization and individual to participate together in the objective pursuit.

In still yet another embodiment, a method for managing organizational participation in an objective pursuit is provided. The method includes a step of providing a first local computer operated by an individual, wherein a platform is provided for initiating an objective pursuit, wherein the platform is capable of allowing the individual to initiate the objective pursuit of the individual's choice. The method further includes a next step of providing a central server in communication with the first local computer, the central server having a verification loop to verify the credentials of the individual, wherein the central server is capable of creating a database for the objective pursuit. The central server having a governance loop capable of taking permission from the individual to propagate the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The method further comprise a step of providing a second local computer in communication with the central server operated by or on behalf of the organization, wherein a platform is provided for the organization to participate in the objective pursuit.

In still yet another embodiment, a method for managing organizational participation in an objective pursuit is provided. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The method further comprises a step of providing a second local computer in communication with the central server to be operated by or on behalf of the organization, wherein the platform is provided for the organization to participate in the objective pursuit.

In still yet another embodiment, a method for managing organizational participation in an objective pursuit is provided. The method includes a step of providing a first local computer system to be operated by an individual, wherein a platform is provided for initiating an objective pursuit, wherein the platform is capable of allowing the individual to initiate the objective pursuit of the individual's choice. In a next step the method provides a central server in communication with the first local computer system, the central server having a verification loop to verify the credentials of the individual, wherein the central server is capable for creating a database for the objective pursuit. The central server having a governance loop capable of taking permission from the individual to propagate the objective pursuit. In a next step the method provides a second local computer operated by or on behalf of an organization, wherein the platform is provided for the organization to evaluate the database for objective pursuits. The organization elects to support at least one objective pursuit from the database for the objective pursuits. The central server is capable of informing the individual of the organization's election of supporting the objective pursuit. The central server reinitiates the governance loop to enable the individual to either accept or decline the organization's support. The individual accepts or declines the organization's support using the first local computer system operated by the individual.

In yet another embodiment, a method for keeping a record of objective pursuits of an individual is provided. The method includes a first step of providing a first local computer operated by an individual. A platform is provided in the first local computer for including an objective pursuit. The platform is capable of allowing the individual to include the objective pursuit of the individual's choice. In a second step the method includes providing a central server in communication with the first local computer system. The central server has a verification loop to verify the credentials of the individual. The central server is capable for creating a database for the objective pursuit. The central server has a governance loop capable of taking permission from the individual to propagate the objective pursuit. In a third step the method provides an objective pursuit ledger. The objective pursuit ledger keeps a record of the objective pursuits of the individual. The objective pursuit ledger serves as a ready reckoner of the objective pursuits of the individual.

In still yet another embodiment, a method for managing organizational participation in an objective pursuit is provided. The method provides a first local computer. The first local computer is operated by an individual, A platform is provided for initiating an objective pursuit. The platform is capable of allowing the individual to initiate the objective pursuit of the individual's choice. The method further provides a central server in communication with the first local computer. The central server is capable of creating a database for the objective pursuit. The central server includes a governance loop capable of taking permission from the individual to propagate the objective pursuit. The method also provides a mechanism. The mechanism is operated by an individual. The individual is capable of taking a photograph of the objective pursuits using the mechanism. The photographs include details comprising identity of the individual. The individual is capable of uploading the photograph in the platform.

In still yet another embodiment, a method for managing organizational participation in an objective pursuit is provided. The method provides a first local computer. The first local computer is operated by an individual. A platform is provided for including an objective pursuit. The platform is capable of allowing the individual to include the objective pursuit of the individual's choice. The method further provides a central server in communication with the first local computer. The central server is capable of creating a database for the objective pursuit. The method further provides an objective pursuit ledger. The objective pursuit ledger keeps a record of the objective pursuits of the individual. The method also provides a mechanism. The mechanism is operated by the individual. The individual is capable of taking a photograph of the objective pursuits using the mechanism. The photographs comprise details comprising identity of the individual. The individual is capable of uploading the photograph in the platform.

In still yet another embodiment a method for keeping a record of objective pursuits of an individual is provided. The method provides a first local computer. The first local computer is operated by an individual. A platform is provided for including an objective pursuit. The platform is capable of allowing the individual to include the objective pursuit of the individual's choice. The method also provides a central server in communication with the first local computer system. The central server having a verification loop to verify the credentials of the individual. The central server is capable for creating a database for the objective pursuit. The central server has a governance loop capable of taking permission from the individual to propagate the objective pursuit. The system also provides an objective pursuit ledger. The objective pursuit ledger keeps a record of the objective pursuits of the individual. The objective pursuit ledger serves as a ready reckoner of the objective pursuits of the individual. The system further provides a mechanism operated by the individual. The individual is capable of taking a photograph of the objective pursuits using the mechanism. The photographs comprise details comprising identity of the individual. The individual is capable of uploading the photograph in the platform.

The system and method included herein present a new paradigm in organization management and organization design that allows us to re-imagine and re-design several existing processes to better address the problems they attempt to solve. Also this holds the potential to design and develop entirely new organization processes that may be effective in solving some of our unsolved problems and those that of next generation complexity that are bound to surface in the future.

The technical advantage of a total polling approach over representative sampling approach may be apparent. Quality of data may be superior leading to better decisions. Acceptability of decisions by individuals or constituents may be better as everyone gets heard. Authenticity of decisions may be significantly higher than a representative approach as people take responsibility for decisions. Since a lot of polling can be passive and those that are active are permission based, we can avoid polling fatigue that may be a likely negative effect of such an approach.

Complete commercial advantages of this approach are less obvious. However, we have identified applications in the fields like employee citizenship and employee development that have found early acceptance with business corporations. We believe these concepts may be applied to Customer Citizenship and Micro Market Development in near to medium term. There can be several other applications in the long term.

The foregoing embodiments meet the overall objectives of this disclosure as summarized above. However, it will be clearly understood by those skilled in the art that the foregoing description has been made in terms only of the most preferred specific embodiments. Therefore, many other changes and modifications clearly and easily can be made that are also useful improvements and definitely outside the existing art without departing from the scope of the present disclosure, indeed which remain within its very broad overall scope, and which disclosure is to be defined over the existing art by the appended claims.

We claim:

1. A system for managing organizational participation in an objective pursuit comprising:
a first local computer operated by an individual, wherein a platform is provided for initiating an objective pursuit, wherein the platform is capable of allowing the individual to initiate the objective pursuit of the individual's choice;
a central server in communication with the first local computer, wherein the central server is capable of creating a database for the objective pursuit, and
a mechanism operated by the individual, wherein the individual is capable of taking a photograph of the objective pursuits using the mechanism, wherein the photographs comprise details comprising identity of the individual, wherein the individual is capable of uploading the photograph in the platform.

2. The system of claim 1, wherein the details comprise identity of the individual, location where the photograph is taken, date where the photograph is taken, time where the photograph is taken, type of the objective pursuit, motivation for the objective pursuit, number of individuals involved in the objective pursuit, involvement of any corporate in the objective pursuit, and beneficiaries of the objective pursuit.

3. The system of claim 1, wherein the objective pursuit includes an act of volunteering.

4. The system of claim 2, wherein the act of volunteering comprises undertaking an act of teaching in a school, painting a school, and giving monetary or other donations to a school.

5. The system of claim 1, wherein the objective pursuits may include those objective pursuits that are initiated by, supported by, and actively participated in by the individual.

6. The system of claim 1, wherein the mechanism comprises of a device comprising a software application that enables the device to capture a photograph and attach the details comprising identity of the individual to the photograph.

7. The system of claim 1, wherein the central server further comprises a verification loop, wherein the verification loop is capable of verifying the credentials of the individual initiating the objective pursuit.

8. The system of claim 1, wherein the central server further comprises a governance loop, wherein the governance loop is capable of taking permission from the individual to propagate the objective pursuit with at least one other individual.

9. The system of claim 1, wherein the governance loop is capable of taking permission from the individual to propagate the objective pursuit with at least one organization.

10. A system for managing organizational participation in an objective pursuit comprising:
a first local computer operated by an individual, wherein a platform is provided for including an objective pursuit, wherein the platform is capable of allowing the individual to include the objective pursuit of the individual's choice;
a central server in communication with the first local computer, wherein the central server is capable of creating a database for the objective pursuit;
an objective pursuit ledger, wherein the objective pursuit ledger keeps a record of the objective pursuits of the individual, and
a mechanism operated by the individual, wherein the individual is capable of taking a photograph of the objective pursuits using the mechanism, wherein the photographs comprise details comprising identity of the individual, wherein the individual is capable of uploading the photograph in the platform.

11. The system of claim 10, wherein the record of the objective pursuits of the individual is translated into different rewards including points and cash incentives.

12. The system of claim 10, wherein the system enables the individual to possess a universal profile.

13. The system of claim 10, wherein the record of the objective pursuits of the individual can be maintained off line or online.

14. The system of claim 10, wherein the central server further comprises a verification loop, wherein the verification loop is capable of verifying the credentials of the individual initiating the objective pursuit.

15. The system of claim 10, wherein the central server further comprises a governance loop, wherein the governance loop is capable of taking permission from the individual to propagate the objective pursuit with at least one other individual.

16. The system of claim 10, wherein the governance loop is capable of taking permission from the individual to propagate the objective pursuit with at least one organization.

17. A system for keeping a record of objective pursuits of an individual comprising:
a first local computer operated by an individual, wherein a platform is provided for including an objective pursuit, wherein the platform is capable of allowing the individual to include the objective pursuit of the individual's choice;
a central server in communication with the first local computer system, the central server having a verification loop to verify the credentials of the individual, wherein the central server is capable for creating a database for the objective pursuit, wherein the central server has a governance loop capable of taking permission from the individual to propagate the objective pursuit;
an objective pursuit ledger, wherein the objective pursuit ledger keeps a record of the objective pursuits of the individual, and wherein the objective pursuit ledger serves as a ready reckoner of the objective pursuits of the individual; and
a mechanism operated by the individual, wherein the individual is capable of taking a photograph of the objective pursuits using the mechanism, wherein the photographs comprise details comprising identity of the individual, wherein the individual is capable of uploading the photograph in the platform.

18. A method for managing organizational participation in an objective pursuit comprising:
providing a first local computer, wherein the first local computer is operated by an individual, wherein a platform is provided for initiating an objective pursuit, wherein the platform is capable of allowing the individual to initiate the objective pursuit of the individual's choice;
providing a central server in communication with the first local computer, wherein the central server is capable of creating a database for the objective pursuit, and wherein the central server comprises a governance loop capable of taking permission from the individual to propagate the objective pursuit; and
providing a mechanism, wherein the mechanism is operated by an individual, wherein the individual is capable of taking a photograph of the objective pursuits using the mechanism, wherein the photographs comprise details comprising identity of the individual, wherein the individual is capable of uploading the photograph in the platform.

19. A method for managing organizational participation in an objective pursuit comprising:
providing a first local computer, wherein the first local computer is operated by an individual, wherein a platform is provided for including an objective pursuit, wherein the platform is capable of allowing the individual to include the objective pursuit of the individual's choice;
providing a central server in communication with the first local computer, wherein the central server is capable of creating a database for the objective pursuit;
providing an objective pursuit ledger, wherein the objective pursuit ledger keeps a record of the objective pursuits of the individual, and
providing a mechanism, wherein the mechanism is operated by an individual, wherein the individual is capable of taking a photograph of the objective pursuits using the mechanism, wherein the photographs comprise details comprising identity of the individual, wherein the individual is capable of uploading the photograph in the platform.

20. A method for keeping a record of objective pursuits of an individual comprising:
providing a first local computer, wherein the first local computer is operated by an individual, wherein a platform is provided for including an objective pursuit, wherein the platform is capable of allowing the individual to include the objective pursuit of the individual's choice;
providing a central server in communication with the first local computer system, the central server having a verification loop to verify the credentials of the individual, wherein the central server is capable for creating a database for the objective pursuit, wherein the central server has a governance loop capable of taking permission from the individual to propagate the objective pursuit;
an objective pursuit ledger, wherein the objective pursuit ledger keeps a record of the objective pursuits of the individual, and wherein the objective pursuit ledger serves as a ready reckoner of the objective pursuits of the individual; and
providing a mechanism operated by the individual, wherein the individual is capable of taking a photograph of the objective pursuits using the mechanism, wherein the photographs comprise details comprising identity of the individual, wherein the individual is capable of uploading the photograph in the platform.
